(19) United States
(12) Patent Application Publication
(10) Pub. No.: US 2025/0174378 A1
(43) Pub. Date: May 29, 2025

(54) PPTC DEVICE INCLUDING MULTILAYER ELECTRODES

(71) Applicant: Littelfuse, Inc., Chicago, IL (US)

(72) Inventors: Nina Liu, Shanghai (CN); Pinghong Li, Shanghai (CN); ChiHao Ku, New Taipei City (TW); Bing Wang, Shanghai (CN); Werner Johler, Pfaeffikon (CH)

(73) Assignee: Littelfuse, Inc., Chicago, IL (US)

(21) Appl. No.: 18/954,973

(22) Filed: Nov. 21, 2024

(30) Foreign Application Priority Data
Nov. 24, 2023 (CN) 2023115792271

(51) Int. Cl. H01C 7/02; H01C 1/14

(52) U.S. Cl. CPC H01C 7/028; H01C 1/1406

(57) ABSTRACT

Approaches provided herein include a protection device assembly including multilayer electrodes. In some embodiments, a protection device assembly may include a protection component, a first electrode layer extending along a first main side of the protection component, and a second electrode layer extending along a second main side of the protection component. The protection device assembly may further include a first substrate layer disposed over at least one of: the first electrode layer, and the second electrode layer, a foil layer disposed over the first substrate layer, wherein the foil layer is partially separated from the first electrode layer by the first substrate layer, and a solder pad extending around an end of the protection component and the first substrate layer, wherein the solder pad is in contact with the foil layer.

### CROSS-REFERENCE TO CORRESPONDING APPLICATIONS

This application claims the benefit of priority to, Chinese Patent Application No. 2023115792271, filed Nov. 24, 2023, entitled “PPTC DEVICE INCLUDING MULTILAYER ELECTRODES,” which application is incorporated herein by reference in its entirety.

### FIELD OF THE DISCLOSURE

The disclosure relates generally to polymeric temperature coefficient (PTC) devices and, more particularly, to polymeric PTC devices including multilayer electrodes.

### BACKGROUND OF THE DISCLOSURE

One known resettable fuse is a positive temperature coefficient (“PTC”) device. PTC thermistor materials rely on a physical characteristic germane to many conductive materials, namely, that the resistivity of the conductive materials increases with temperature. Crystalline polymers made electrically conductive via the disbursement of conductive fillers therein, exhibit this PTC effect. The polymers generally include polyolefins such as polyethylene, polypropylene and ethylene/propylene copolymers. Certain doped ceramics such as barium titanate also exhibit PTC behavior.

The conductive fillers cause the resistivity of the PTC thermistor material to increase as the temperature of the material increases. At temperatures below a certain value, the PTC thermistor material exhibits a relatively low, constant resistivity. However, as the temperature of the PTC thermistor material increases beyond this point, the resistivity increases sharply with only a slight increase in temperature.

If a load protected by a PTC thermistor material is short circuited, the current flowing through the PTC thermistor material increases and the temperature of the PTC thermistor material (due to the above-mentioned i²R heating) rises rapidly to a critical temperature. At the critical temperature, the PTC thermistor material dissipates a great deal of power causing the rate at which the material generates heat to be greater than the rate at which the material can lose heat to its surroundings. The power dissipation only occurs for a short period of time (e.g., a fraction of a second). However, the increased power dissipation raises the temperature and resistance of the PTC thermistor material, limiting the current in the circuit to a relatively low value. The PTC thermistor material accordingly acts as a form of a fuse.

Upon interrupting the current in the circuit, or removing the condition responsible for the short circuit, the PTC thermistor material cools below its critical temperature to its normal operating, low resistance state. The result is a resettable overcurrent circuit protection material.

Even though the PTC thermistor materials operate at lower resistances under normal conditions, the normal operating resistances for PTC thermistor materials are higher than that of other types of fuses, such as non-resettable metallic fuses.

Accordingly, an improved small package size device is needed.

### SUMMARY

In one or more embodiments, a protection device assembly a protection component, a first electrode layer extending along a first main side of the protection component, and a second electrode layer extending along a second main side of the protection component. The protection device assembly may further include a first substrate layer disposed over at least one of: the first electrode layer, and the second electrode layer, a foil layer disposed over the first substrate layer, wherein the foil layer is partially separated from the first electrode layer by the first substrate layer, and a solder pad extending around an end of the protection component and the first substrate layer, wherein the solder pad is in contact with the foil layer.

In one or more embodiments, a polymeric positive temperature coefficient (PPTC) device may include a PPTC protection component, a first electrode layer extending along a first main side of the PPTC protection component, and a second electrode layer extending along a second main side of the PPTC protection component. The PPTC protection component may further include a first substrate layer disposed over the first electrode layer and a second substrate layer disposed over the second electrode layer, and a first foil layer disposed over the first substrate layer, wherein the foil layer is partially separated from the first electrode layer by the first substrate layer. The PPTC protection component may further include a second foil layer disposed over the second substrate layer, wherein the second foil layer is partially separated from the second electrode layer by the second substrate layer, and a solder pad extending around an end of the PPTC protection component and the first substrate layer, wherein the solder pad is in contact with the first foil layer or the second foil layer.

In one or more embodiments, a method of forming a protection device assembly may include providing a PPTC protection component, forming a first electrode layer along a first main side of the PPTC protection component, and forming a second electrode layer along a second main side of the PPTC protection component. The method may further include forming a first substrate layer over the first electrode layer and forming a second substrate layer disposed over the second electrode layer, and forming a first foil layer over the first substrate layer, wherein the foil layer is partially separated from the first electrode layer by the first substrate layer. The method may further include forming a second foil layer over the second substrate layer, wherein the second foil layer is partially separated from the second electrode layer by the second substrate layer, and forming a solder pad around an end of the PPTC protection component and around the first substrate layer, wherein the solder pad is in contact with the first foil layer or the second foil layer.

### BRIEF DESCRIPTION OF THE DRAWINGS

The accompanying drawings illustrate example approaches of the disclosed embodiments so far devised for the practical application of the principles thereof, and in which:

FIG. 1A is a photograph of a side view of an assembly according to an example approach of the disclosure;

FIG. 1B is a side view of an assembly according to an example approach of the disclosure;

FIG. 2 is a top view of the assembly along cut line A-A of FIG. 1B according to an example approach of the disclosure;

FIG. 3 is a top view of the assembly according to an example approach of the disclosure;

FIG. 4 is a side cross-sectional view of the device of the assembly of FIG. 3 along cut line B-B, according to an example approach of the disclosure;

FIG. 5 is a side cross-sectional view of a device, according to an example approach of the disclosure;

FIG. 6 is a side cross-sectional view of a device, according to an example approach of the disclosure;

FIG. 7 is a side cross-sectional view of a device, according to an example approach of the disclosure;

FIG. 8 is a side cross-sectional view of a device, according to an example approach of the disclosure;

FIG. 9 is a side cross-sectional view of a device, according to an example approach of the disclosure;

FIG. 10 is a side cross-sectional view of a device, according to an example approach of the disclosure;

FIG. 11 is a diagram illustrating voltage and resistance for the device of FIG. 10, according to an example approach of the disclosure;

FIG. 12 is a side cross-sectional view of a device, according to an example approach of the disclosure;

FIG. 13 depicts a process of forming a PPTC device according to an example approach of the disclosure; and

FIGS. 14-15 depict example foil layers according to embodiments of the disclosure.

The drawings are not necessarily to scale. The drawings are merely representations, not intended to portray specific parameters of the disclosure. The drawings are intended to depict typical embodiments of the disclosure, and therefore should not be considered as limiting in scope. In the drawings, like numbering represents like elements.

Furthermore, certain elements in some of the figures may be omitted, or illustrated not-to-scale, for illustrative clarity. Furthermore, for clarity, some reference numbers may be omitted in certain drawings.

### DETAILED DESCRIPTION

Embodiments in accordance with the present disclosure will now be described more fully hereinafter with reference to the accompanying drawings. The apparatuses, devices, and methods may be embodied in many different forms and should not be construed as being limited to the embodiments set forth herein. Rather, these embodiments are provided so that this disclosure will be thorough and complete, and will fully convey the scope of the system and method to those skilled in the art.

As will be described herein, embodiments of the disclosure provide a PPTC device, which includes one or more multilayer electrode structures. The PPTC may consist of an organic conductive layer, which may be a polymeric positive temperature component (e.g., made of/from PTC solid sheet or liquid material) layer, conductive electrodes layers (e.g., of copper), high resistive electrode layers, insulation layers (e.g., substrate made of prepreg or FR4 , ceramic, etc.), and/or coating layers. The high resistive electrodes may be made from a conductive layer, which contact positive temperature component indirectly.

The PPTC of the present disclosure improves resistance distribution, wherein the total resistance consists of PTC resistance (i.e., variable resistance) and high resistive foil (i.e., fixed resistance). The high resistive foil is separated by one or more insulation layers, which causes the foil to act as an independent electrode, resulting in more space for resistance design. Compared with traditional applications in which the PTC is the total resistance source, the high-resistive foil layer shares more resistance, which can tighten the resistance window for specific applications. Furthermore, voltage withstand performance can be improved because the high resistive foil shares the voltage drop in series per layers of the structure with PTC layer.

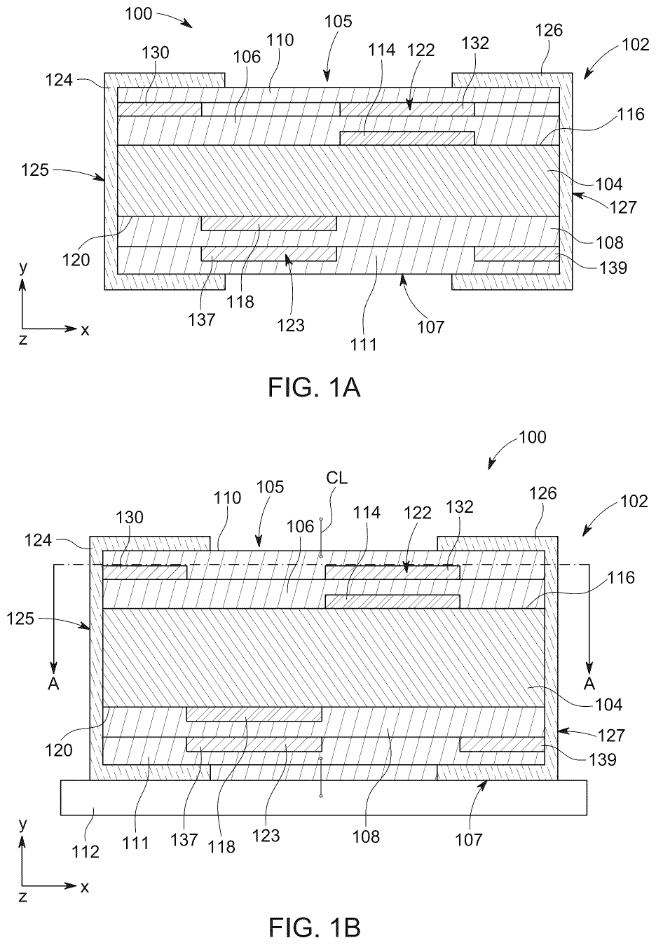

Turning to FIGS. 1A-1B, illustrated is an embodiment of an assembly 100 and a device 102 in accordance with the present disclosure. As shown, the device 102, may be a PTC device or a polymeric PTC device. In some embodiments, the device 102 may be an Electronic Industries Alliance (EIA) surface mount device, e.g., type advanced SMDC0201. For ease of explanation, the device 102 may be defined by a first end 125 opposite a second end 127, and a top side 105 opposite a bottom side 107. The device 102 may further include a first side opposite a second side (e.g., in and out of the page).

The device 102 includes a protection component 104 disposed between a first substrate layer 106 and a second substrate layer 108. Atop the first substrate layer 106 may be third substrate layer 110, and beneath the second substrate layer 108 may be fourth substrate layer 111. Additional substrate layers may be present in alternative embodiments. In some embodiments, the substrate layers are made of a same material, such as an FR-4 material or a polyimide. The illustrated device 102 may be located in, for example, a charge/discharge circuit of a secondary cell, and used as a circuit protection device to interrupt an excess current when such current passes through the circuit. As shown in FIG. 1B, the device 102 may be connected to a printed circuit board (PCB) 112 by a solder.

In some embodiments, the protection component 104 is selected from the non-limiting group consisting of: fuses, PTCs, NTCs, ICs, sensors, MOSFETS, resistors, and capacitors. Of these protection components, ICs and sensors are considered to be active protection components, while PTCs, NTCs, and fuses are considered to be passive components. In the embodiment shown, the protection component 104 may be a polymeric PTC. It will be appreciated, however, that this arrangement is non-limiting, and the number and configuration of protection components may vary depending on the application.

The PTC material of the protection component 104 may be made of a positive temperature coefficient conductive composition comprising a polymer and a conductive filler. The polymer of the PTC material may be a crystalline polymer selected from the group consisting of polyethylene, polypropylene, polyoctylene, polyvinylidene chloride and a mixture thereof. The conductive filler may be dispersed in the polymer and is selected from the group consisting of carbon black, metal powder, conductive ceramic powder and a mixture thereof. Furthermore, to improve sensitivity and physical properties of the PTC material, the PTC conductive composition may also include an additive, such as a photo initiator, cross-link agent, coupling agent, dispersing agent, stabilizer, anti-oxidant and/or nonconductive anti-arcing filler.

As shown, a first electrode layer 114 may extend along a first main side 116 of the protection component 104, and a second electrode layer 118 may extend along a second main side 120 of the protection component 104. The first substrate layer 106 may be disposed over the first electrode layer 114, while the second substrate layer 108 may be disposed around/over the second electrode layer 118 such that the second electrode layer 118 is between the second main side 120 of the protection component 104 and the second substrate layer 108.

The first electrode layer 114 and the second electrode layer 118 may be made from copper. However, it will be appreciated that alternative materials may be used. For example, the first and second electrode layers 114, 118 can be of one or more metals, such as silver, copper, nickel, tin and alloys thereof, and may be applied to the first and second main sides 116, 120 and/or a surface of the first substrate layer 106 and the second substrate layer 108 by any number of ways. For example, the first electrode layer 114 and the second electrode layer 118 can be applied via electroplating, sputtering, printing, laminating, etc.

The device 102 may further include a first foil layer 122 formed atop the first substrate layer 106, and a second coil layer 123 formed beneath the second substrate layer 108. The third substrate layer 110 may be formed around the first foil layer 122, while the fourth substrate layer 111 may be formed around second foil layer 123. The first and second foil layers 122, 123 may be high-resistive layers. The resistance of the first and second foil layers 122, 123 may be greater than a resistance of the first and second electrode layers 114, 118. In some embodiments, a material or materials for the first and second foil layers 122, 123 may be a copper plated nickel-phosphorus alloy and/or a nickel-chrome alloy.

As further shown, a first solder pad 124 may extend around the first end 125 of the protection component 104, and a second solder pad 126 may extend around the second end 127 of the protection component 104. In some embodiments, the first solder pad 124 may be formed over the third substrate layer 110 and beneath the fourth substrate layer 111, and may be in contact with the first foil layer 122. The second solder pad 126 may be formed over the third substrate layer 110 and beneath the fourth substrate layer 111, and may be in contact with the second foil layer 123. The first and second solder pads 124, 126 may be terminations formed by, for example, standard plating techniques. The terminations can be multiple layers of metal, such as electrolytic copper, electrolytic tin, silver, nickel or other metal or alloy as desired. The terminations are sized and configured to enable the device 102 to be mounted in a surface mount manner onto the PCB 112.

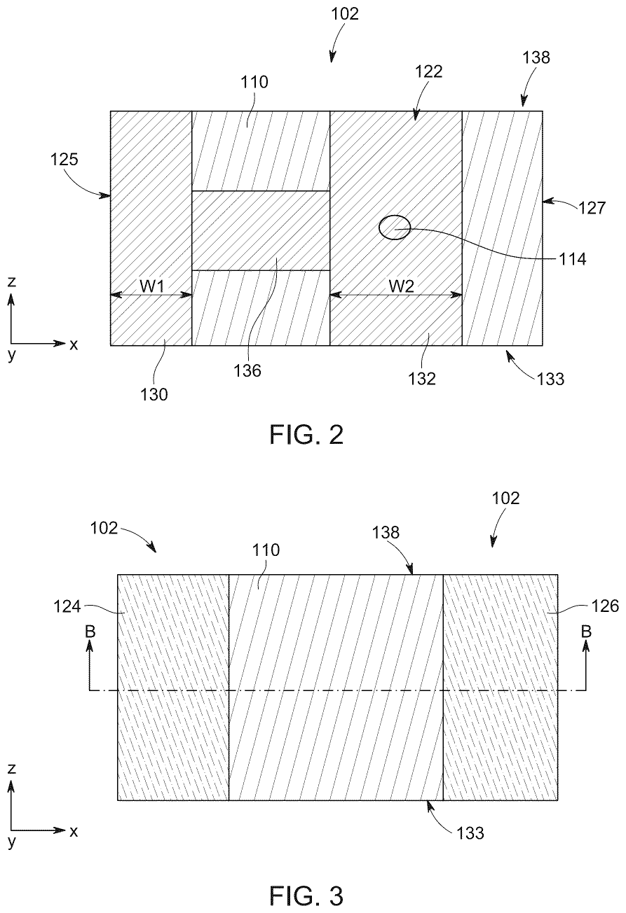

Referring to FIG. 2, the first foil layer 122 will be described in greater detail. As further shown, the first foil layer 122 may include a first section 130 extending between a first side 138 and a second side 133 of the device 102. In the embodiment shown, the first section 130 further extends to the first end 125 of the device 102. The first foil layer 122 may further include a second section 132 extending between the first side 138 and the second side 133 of the device 102. As shown, the second section 132 is electrically connected with the first electrode 114, which extends through an opening of the second section 132. In some embodiments, the second section 132 does not extend entirely to the second end 127 of the device 102. The first foil layer 122 may further include a third section 136 connecting the first and second sections 130, 132. As shown, the third section 136 may be partially surrounded by the third substrate layer 110. In some embodiments, a first width ‘W1’ of the first section 130, along the x-direction, is less than a second width ‘W2’ of the second section 132. Although not shown, the second electrode layer 118 and the second foil layer 123 may be configured substantially the same as the first electrode layer 114 first foil layer 122. In other embodiments, the second electrode layer 118 may have a different layout than the first electrode layer 114, and/or the second foil layer 123 may have a different layout than the first foil layer 122.

Referring again to FIG. 1B, the second section 132 of the first foil layer 122 may be substantially vertically aligned with the first electrode layer 114. Furthermore, the second section of the first foil layer 122 may have substantially the same width (e.g., in the x-direction) as the first electrode layer 114. The second foil layer 123 and the second electrode layer 118 may be similarly arranged along the underside of the protection component 104. In the embodiment shown, the second section 132 of the first foil layer 122 and the first electrode layer 114 may both extend approximately to a centerline ‘CL’ of the device 102, and the second solder pad 126 may extend partially over the second section 132 of the first foil layer 122 and the first electrode layer 114. Meanwhile, the first solder pad 124 may extend entirely over the first section 130 of the first foil layer 122. Similarly, a second section 137 of the second foil layer 123 and the second electrode layer 118 may both extend approximately to the centerline ‘CL’ of the device 102, and the first solder pad 124 may extend partially over the second section 137 of the second foil layer 123 and the second electrode layer 118. The second solder pad 126 may extend entirely over a first section 139 of the second foil layer 123.

In the embodiment of FIG. 1A, the second section 132 of the first foil layer 122 and the first electrode layer 114 may be offset along the x-direction relative to one another. For example, the second section 132 of the first foil layer 122 may extend closer to a center of the device 102 than first electrode layer 114, while the first electrode layer 114 may extend closer to the second end 127 of the device 102. Furthermore, the second electrode layer 118 may extend closer to the center of the device 102 than the second section 137 of the second foil layer 123, while the second section 137 of the second foil layer 123 may extend closer to the first end 125 of the device 102.

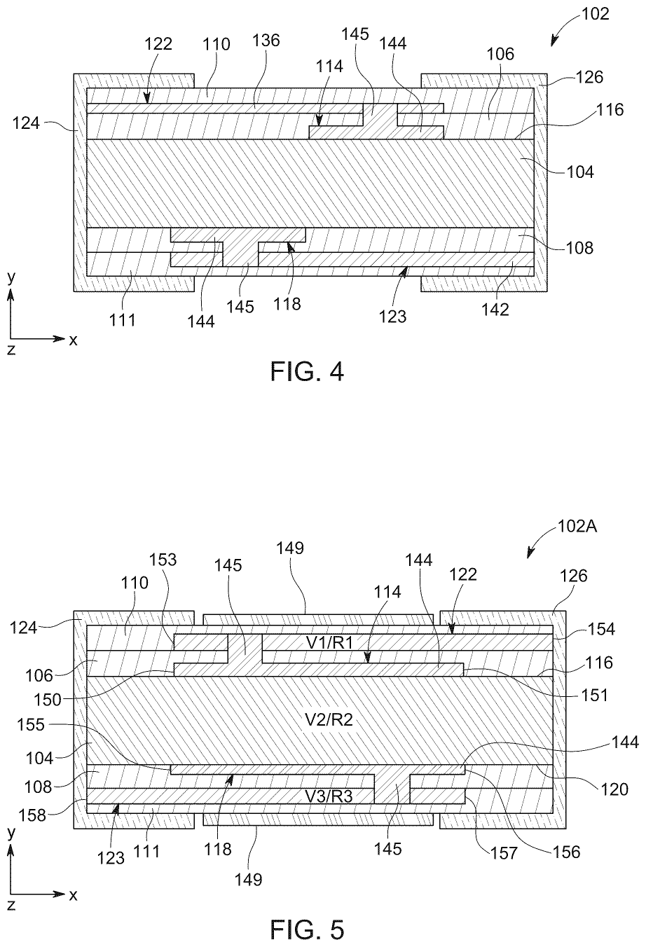

FIG. 4 is a side cross-sectional view of the device 102 along cutline B-B of FIG. 3. As shown, cutline B-B is taken through a center of the third section 136 of the first foil layer 122 and through a center of a third section 142 of the second foil layer 123. As shown, the first electrode layer 114 and the second electrode layer 118 may each include a base 144 and a via 145 extending from the base 144. In this embodiment, the base 144 of the first electrode 114 is disposed directly atop the first main side 116 of the protection component 104, and the via 145 extends from the base 144 and through an opening of the first foil layer 122. Similarly, the base 144 of the second electrode layer 118 is in direct contact with the second main side 120 of the protection component 104, and the via 145 extends from the base 144 and through an opening of the second foil layer 123.

In the device 102, the voltage and resistance are divided between the first foil layer 122, the protection component 104, and the second foil layer 123. The total resistance, Rₜₒₜₐₗ, for the device 102 is given by R1+R2+R3, while the total voltage, Vₜₒₜₐₗ, for the device 102 is given by V1+V2+V3.

FIG. 5 demonstrates another device 102A according to embodiments of the disclosure. The device 102A may be the same or similar as device 102 described above. As such, only certain aspects of the device 102A will hereinafter be described for the sake of brevity.

As shown, the first electrode layer 114 and the second electrode layer 118 may each include the base 144 and the via 145 extending from the base 144. In this embodiment, the base 144 of the first electrode 114 is disposed directly atop the first main side 116 of the protection component 104, and the via 145 extends from the base 144 and through an opening of the first foil layer 122. Similarly, the base 144 of the second electrode layer 118 is in direct contact with the second main side 120 of the protection component 104, and the via 145 extends from the base 144 and through an opening of the second foil layer 123.

The base 144 of the first electrode layer 114 may be separated from the first foil layer 122 by the first substrate layer 106, and may have a width (e.g., in the x-direction) defined by a first end 150 and a second end 151. As shown, the first end 150 may be covered or overlapped by the first solder pad 124 in the y-direction, while the second end 151 may be covered or overlapped by the second solder pad 126 in the y-direction. In the embodiment shown, the first end 150 is substantially aligned with a first end 153 of the first foil layer 122, while a second end 154 of the first foil layer 122 extends to the second solder pad 126.

The base 144 of the second electrode layer 118 may be separated from the second foil layer 123 by the second substrate layer 108, and may have a width (e.g., in the x-direction) defined by a first end 155 and a second end 156. As shown, the first end 155 may be covered or overlapped by the first solder pad 124 in the y-direction, while the second end 156 may be covered or overlapped by the second solder pad 126 in the y-direction. In the embodiment shown, the second end 156 is substantially aligned with a first end 157 of the second foil layer 123, while a second end 158 of the first foil layer 122 extends to the first solder pad 124.

As further shown, a coating layer 149 may be provided along one or more sides of the device 102A. For example, the coating layer 149 may be formed atop the third substrate layer 110, and the coating layer 149 may be formed along the fourth substrate layer 111. The coating layer 149 may be provided between the first and second solder pads 124, 126.

In the device 102A, the voltage and resistance are divided between the first foil layer 122, the protection component 104, and the second foil layer 123. As shown, total resistance, Rₜₒₜₐₗ, for the device 102A is given by R1+R2+R3, while the total voltage, Vₜₒₜₐₗ, for the device 102A is given by V1+V2+V3.

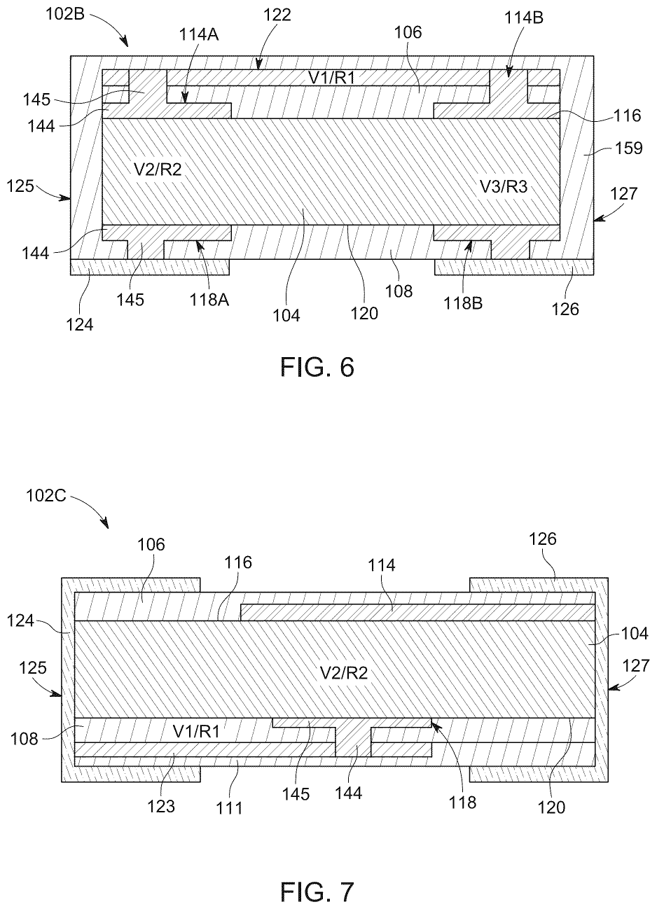

FIG. 6 demonstrates another device 102B according to embodiments of the disclosure. The device 102B may be the same or similar as the devices described above. As such, only certain aspects of the device 102B will hereinafter be described for the sake of brevity.

As shown, the first electrode layer may include a first section 114A separated from a second section 114B by the first substrate layer 106. Each of the first and second sections 114A, 114B may have the base 144 and the via 145 extending from the base 144. Similarly, the second electrode layer may include a first section 118A separated from a second section 118B by the second substrate layer 108, wherein each of the first and second sections 118A, 118B may include via 145 extending from base 144 and through the openings of the first foil layer 122. In this embodiment, the base 144 of the first and second sections 114A, 114B are disposed directly atop the first main side 116 of the protection component 104, while the vias 145 extend perpendicularly from each respective base 144. Similarly, the base 144 of the first and second sections 118A, 118B of the second electrode layer are in direct contact with the second main side 120 of the protection component 104, while the vias 144 extend through the second substrate layer 108 and make contact with the first solder pad 124 and the second solder pads 126.

In the embodiment shown, the first and second solder pads 124, 126 extend only along a bottom of the second substrate later 108 and do not wrap around the first and second ends 125, 127 of the device 102B. Instead, a third substrate layer 159 may be formed over the first foil layer 122 and wrap around the sides of the protection component 104 and the first and second electrode layers.

In the device 102B, the voltage and resistance are divided between the first foil layer 122 and the protection component 104. As shown, total resistance, Rₜₒₜₐₗ, for the device 102B is given by R1+R2+R3, while the total voltage, Vₜₒₜₐₗ, for the device 102B is given by V1+V2+V3.

FIG. 7 demonstrates another device 102C according to embodiments of the disclosure. The device 102C may be the same or similar as the devices described above. As such, only certain aspects of the device 102C will hereinafter be described for the sake of brevity.

As shown, the first electrode layer 114 is disposed directly atop the first main side 116 of the protection component 104, and the first substrate layer 106 is formed over the first electrode layer 114. The second electrode layer 118 is formed along the second main side 120 of the protection component 104, and includes via 145 extending from base 144. Via 145 extends through the second substrate layer 108 and through the opening of the second foil layer 123. The fourth substrate layer 111 may be formed beneath the second foil layer 123. In the embodiment shown, the first and second solder pads 124, 126 extend around the first and second ends 125, 127 of the device 102C, including beneath the fourth substrate layer 111.

In the device 102C, the voltage and resistance are divided between the second foil layer 123 and the protection component 104. As shown, total resistance, Rₜₒₜₐₗ, for the device 102B is given by R1+R2, while the total voltage, Vₜₒₜₐₗ, for the device 102C is given by V1+V2.

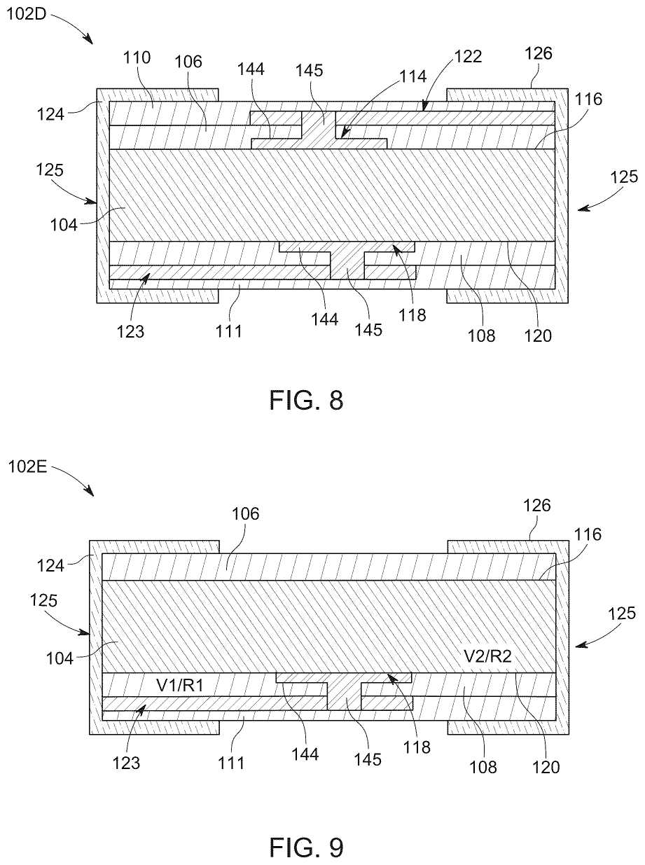

FIG. 8 demonstrates another device 102D according to embodiments of the disclosure. The device 102D may be the same or similar to the devices described above. As such, only certain aspects of the device 102D will hereinafter be described for the sake of brevity.

As shown, the first electrode layer 114 and the second electrode layer 118 may each include the base 144 and the via 145 extending from the base 144. In this embodiment, the base 144 of the first electrode 114 is disposed directly atop the first main side 116 of the protection component 104, and the via 145 extends from the base 144 and through the opening of the first foil layer 122. Similarly, the base 144 of the second electrode layer 118 is in direct contact with the second main side 120 of the protection component 104, and the via 145 extends from the base 144 and through the opening of the second foil layer 123.

The base 144 of the first electrode layer 114 may be separated from the first foil layer 122 by the first substrate layer 106, while the third substrate layer 110 is formed over the first foil layer 122. Similarly, the base 144 of the second electrode layer 118 may be separated from the second foil layer 123 by the second substrate layer 106, while the fourth substrate layer 111 is formed beneath the second foil layer 123. In this embodiment, the first and second electrode layers 114, 118 are not covered or overlapped, in the y-direction, by the first or second solder pads 124, 126. Meanwhile, the first foil layer 122 may extend to the second solder pad 126 and the second foil layer 123 may extend to the first solder pad 124.

In the device 102D, the voltage and resistance are divided between the first foil layer 122, the protection component 104, and the second foil layer 123. The total resistance, Rₜₒₜₐₗ, for the device 102D is given by R1+R2+R3, while the total voltage, Vₜₒₜₐₗ, for the device 102D is given by V1+V2+V3.

FIG. 9 demonstrates another device 102E according to embodiments of the disclosure. The device 102E may be the same or similar as the devices described above. As such, only certain aspects of the device 102E will hereinafter be described for the sake of brevity.

As shown, the second electrode layer 118 is formed along the second main side 120 of the protection component 104, and includes via 145 extending from base 144. Via 145 extends through the second substrate layer 108 and through the opening of the second foil layer 123. The fourth substrate layer 111 may be formed beneath the second foil layer 123. In the embodiment shown, the first and second solder pads 124, 126 extend around the first and second ends 125, 127 of the device 102E, including beneath the fourth substrate layer 111.

In the device 102E, the voltage and resistance are divided between the second foil layer 123 and the protection component 104. As shown, total resistance, Rₜₒₜₐₗ, for the device 102E is given by R1+R2, while the total voltage, Vₜₒₜₐₗ, for the device 102E is given by V1+V2.

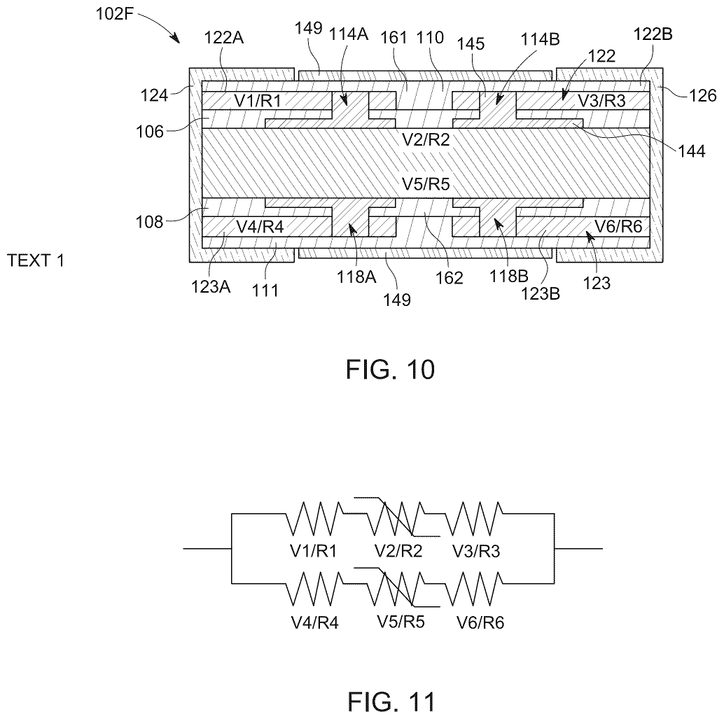

FIG. 10 demonstrates another device 102F according to embodiments of the disclosure. The device 102F may be the same or similar as the devices described above. As such, only certain aspects of the device 102F will hereinafter be described for the sake of brevity.

As shown, the first electrode layer may include the first section 114A separated from a second section 114B by the first substrate layer 106 and the third substrate layer 110. Each of the first and second sections 114A, 115B may have the base 144 and the via 145 extending from the base 144. Each of the vias 145 may extend through an opening of the first foil layer 122. Similarly, the second electrode layer may include the first section 118A separated from a second section 118B by the second substrate layer 108 and the fourth substrate layer 111, wherein each of the first and second sections 118A, 118B may include via 145 extending from base 144 and through the openings of the first foil layer 122. In this embodiment, the base 144 of the first and second sections 114A, 114B are disposed directly atop the first main side 116 of the protection component 104, while the vias 145 extend perpendicularly from each respective base 144. Similarly, the base 144 of the first and second sections 118A, 118B of the second electrode layer are in direct contact with the second main side 120 of the protection component 104, while the vias 144 extend through the second substrate layer 108 and through openings of the second foil layer 123. As shown, the third substrate layer 110 may be formed over the first foil layer 122, and the fourth substrate layer 111 may be formed beneath the second foil layer 123. In some embodiments, the first foil layer 122 may have a first section 122A and a second section 122B separated by a gap 161, and the second foil layer 123 may have a first section 123A and a second section 123B separated by a gap 162. The first foil layer 122 may be formed atop the first substrate layer 106, and the second foil layer 123 may be formed beneath the second substrate layer 108.

As further shown, a coating layer 149 may be provided along one or more sides of the device 102F. For example, the coating layer 149 may be formed atop the third substrate layer 110, and the coating layer 149 may be formed along the fourth substrate layer 111.

As shown in FIG. 11, the voltage and resistance of the device 102E are divided between the first section 122A of the first foil layer 122, the second section 122B of the first foil layer 122, the protection component 104, the first section 123A of the second foil layer 123, and the second section 123B of the second foil layer 123. As shown, total resistance, Rₜₒₜₐₗ, for the device 102E is given by Rₜₒₜₐₗ=((R1+R2+R3)(R4+R5+R6)/(R1+R2+R3+R4+R5+R6)). The total voltage, Vₜₒₜₐₗ, for the device 102E is given by Vₜₒₜₐₗ=V1+V2+V3=V4+V5+V6.

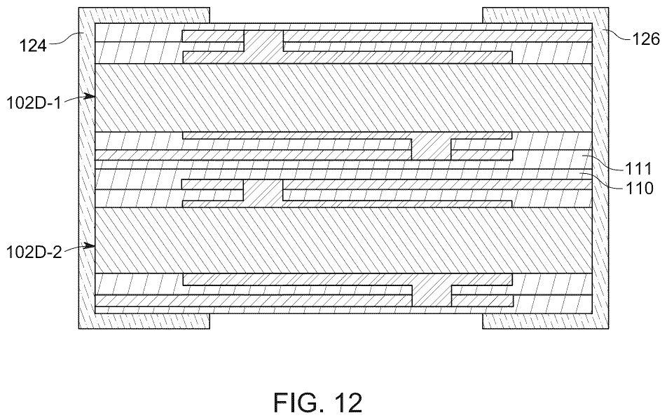

FIG. 12 demonstrates that multiple devices may be stacked in a same structure. For example, a first device 102D-1 may be stacked upon a second device 102D-2, while first and second solder pads 124, 126 are formed about both. In the embodiment shown, the fourth substrate layer 111 of first device 102D-1 may be positioned directly atop the third substrate layer 110 of second device 102D-2. It will be appreciated that first device 102D-1 and second device 102D-2 may have the same or different structure/configuration.

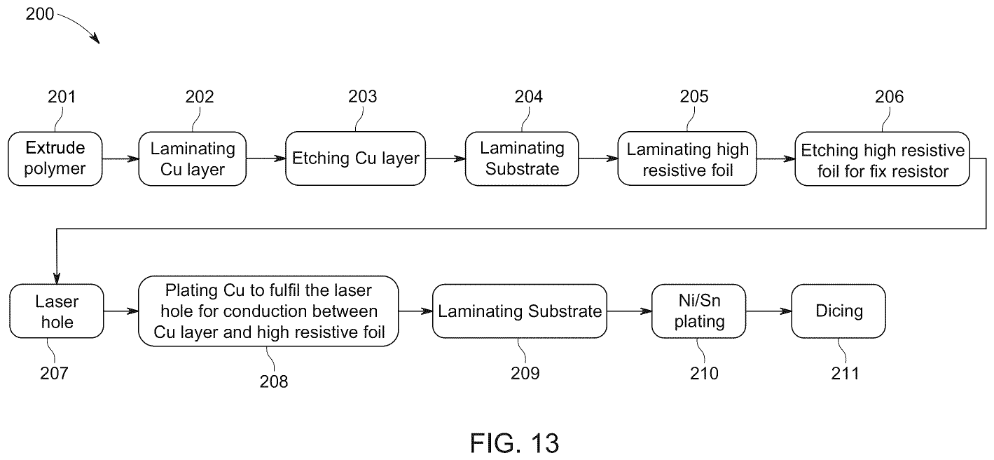

FIG. 13 demonstrates an approach 200 for forming one or more the devices described herein. At block 201, the approach 200 may include extruding a polymer to form the protection component. In some embodiments, the protection component may be a PPTC protection component.

At block 202, the approach 200 may include laminating a copper layer over the protection component.

At block 203, the approach 200 may include etching the copper layer into a desired configuration to form one or more electrodes. In various embodiments. the copper may be etched into any of the electrode layers described herein.

At block 204, the approach 200 may include laminating a first substrate layer over the copper layer.

At block 205, the approach 200 may include laminating a high resistive foil over the first substrate layer, and then etching the high resistive foil for a fixed resistor value, as shown at block 206.

At block 207, the approach 200 may further include forming an opening or hole through the high resistive foil. In some embodiments the opening as a hole, which is lasered.

At block 208, the approach 200 may further include plating the copper layer to fill the opening formed through the high resistive foil to provide conduction between the copper layer and the high resistive foil.

At block 209, the approach 200 may further include laminating another substrate layer over the high resistive foil.

At block 210, the approach 200 may further include a nickel and/or tin plating process to form the first and second solder pads.

At block 211, the approach 200 may further include dicing the layers to form the device.

In some embodiments, prior to the plating process at block 210, one or more of the process steps 201 through 209 may be repeated to form the layers along the second main side of the protection component. For example, one or more electrode layers and one or more high resistive foil layers may be patterned along the second main side of the protection component using the approaches described above.

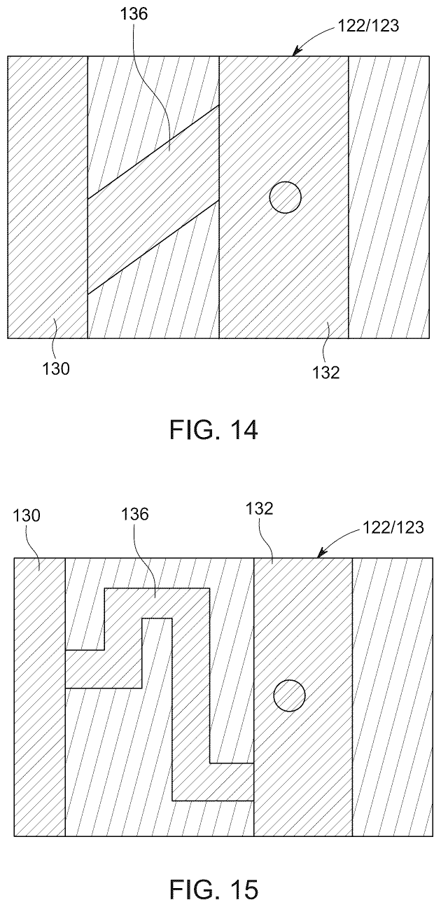

FIGS. 14-15 show some non-limiting examples for the first foil layer 122 and/or the second foil layer 123 described herein. Notably, the third section 136 extending between the first section 130 and the second section 132 may take on a variety of shapes, thicknesses, configurations, etc., as desired, to adjust the resistance of the foil layer.

In sum, the multilayer electrode structure of the present disclosure advantageously makes the high-resistive foil perform as independent layer, resulting in more space for the resistance design and thus greater shared resistance to tighten distribution. Furthermore, the multilayer electrode structure advantageously provides higher binding forces to prevent delaminating and cracking of PPTC devices. The multilayer electrode structure design connects all conductive portions in series, which provides shared voltage on each conductive portion. This prevents all voltage from being across only the PTC, and improves voltage withstand performance (i.e., trip endurance). Still furthermore, embodiments herein advantageously provide a novel manufacturing process for increased miniaturization and diverse components.

The foregoing discussion has been presented for purposes of illustration and description and is not intended to limit the disclosure to the form or forms disclosed herein. For example, various features of the disclosure may be grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended expressions and can be used interchangeably herein.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Furthermore, identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings attached hereto may vary.

Furthermore, the terms “substantial” or “substantially,” as well as the terms “approximate” or “approximately,” can be used interchangeably in some embodiments, and can be described using any relative measures acceptable by one of ordinary skill in the art. For example, these terms can serve as a comparison to a reference parameter, to indicate a deviation capable of providing the intended function. Although non-limiting, the deviation from the reference parameter can be, for example, in an amount of less than 1%, less than 3%, less than 5%, less than 10%, less than 15%, less than 20%, and so on.

Still furthermore, although the illustrative method 200 is described above as a series of acts or events, the present disclosure is not limited by the illustrated ordering of such acts or events unless specifically stated. For example, some acts may occur in different orders and/or concurrently with other acts or events apart from those illustrated and/or described herein, in accordance with the disclosure. In addition, not all illustrated acts or events may be required to implement a methodology in accordance with the present disclosure. Furthermore, the method 200 may be implemented in association with the formation and/or processing of structures illustrated and described herein as well as in association with other structures not illustrated.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, the present disclosure has been described herein in the context of a particular implementation in a particular environment for a particular purpose. Those of ordinary skill in the art will recognize the usefulness is not limited thereto and the present disclosure may be beneficially implemented in any number of environments for any number of purposes. Thus, the claims set forth below are to be construed in view of the full breadth and spirit of the present disclosure as described herein.

What is claimed is:

1. A protection device assembly, comprising:
a protection component;
an electrode layer extending along at least one of the following: a first main side of the protection component, and a second main side of the protection component;
a substrate layer disposed over the electrode layer;
a foil layer disposed over the substrate layer, wherein the foil layer is partially separated from the electrode layer by the substrate layer; and
a solder pad extending around an end of the protection component and the substrate layer, wherein the solder pad is in contact with the foil layer.

2. The protection device assembly of claim 1, further comprising a second substrate layer disposed over the substrate layer.

3. The protection device assembly of claim 1, further comprising a second solder pad extending around a second end of the protection component and the substrate layer.

4. The protection device assembly of claim 1, further comprising a printed circuit board, wherein the first and second solder pads are connected to the printed circuit board by a solder.

5. The protection device assembly of claim 1, wherein the foil layer has a higher resistance than the electrode layer.

6. The protection device assembly of claim 1, wherein foil layer comprises:
a first section extending between a first side and a second side of the protection component;
a second section extending between the first side and the second side of the protection component, wherein the second section is electrically connected with the electrode layer; and
a third section extending between the first and second sections.

7. The protection device assembly of claim 5, wherein the second section is vertically aligned with the electrode layer.

8. The protection device assembly of claim 1, wherein the protection component is a polymeric positive temperature coefficient (PPTC) component.

9. A polymeric positive temperature coefficient (PPTC) device, comprising:
a PPTC protection component;
an electrode layer extending along at least one of the following: a first main side of the PPTC protection component, and a second main side of the PPTC protection component;
a substrate layer disposed over the electrode layer;
a first foil layer disposed over the substrate layer, wherein the first foil layer is partially separated from the electrode layer by the substrate layer; and
a solder pad extending around an end of the PPTC protection component and the substrate layer, wherein the solder pad is in contact with the first foil layer.

10. The PPTC device of claim 9, wherein the electrode layer comprises a first electrode layer extending along the first main side of the PPTC protection component and a second electrode layer extending along the second main side of the PPTC protection component, wherein a second foil layer is disposed over a second substrate layer disposed over the second electrode layer, wherein the second foil layer is partially separated from the second electrode layer by the second substrate layer.

11. The PPTC device of claim 10, further comprising:
a third substrate layer disposed over the first substrate layer, and a fourth substrate layer disposed over the second substrate layer; and
a coating layer disposed atop at least one of: the third substrate layer, and the fourth substrate layer.

12. The PPTC device of claim 10, further comprising a second solder pad extending around a second end of the protection component and the first substrate layer.

13. The PPTC device of claim 8, wherein the first and second foil layers have a higher resistance than the first and second electrode layers.

14. The PPTC device of claim 8, wherein first foil layer comprises:
a first section extending between a first side and a second side of the protection component;
a second section extending between the first side and the second side of the protection component, wherein the second section is electrically connected with the first electrode; and
a third section extending between the first and second sections.

15. The PPTC device of claim 12, wherein the second section of the first foil layer is vertically aligned with the first electrode layer.

16. A method of forming a protection device assembly, comprising:
providing a PPTC protection component;
forming a first electrode layer along a first main side of the PPTC protection component;
forming a second electrode layer along a second main side of the PPTC protection component;
forming a first substrate layer over the first electrode layer and forming a second substrate layer disposed over the second electrode layer;
forming a first foil layer over the first substrate layer, wherein the first foil layer is partially separated from the first electrode layer by the first substrate layer;
forming a second foil layer over the second substrate layer, wherein the second foil layer is partially separated from the second electrode layer by the second substrate layer; and
forming a solder pad around an end of the PPTC protection component and around the first substrate layer, wherein the solder pad is in contact with the first foil layer or the second foil layer.

17. The method of claim 14, further comprising forming a third substrate layer over the first substrate layer, and forming a fourth substrate layer over the second substrate layer.

18. The method of claim 17, further comprising forming a coating layer atop at least one of: the third substrate layer, and the fourth substrate layer.

19. The method of claim 16, further comprising forming a second solder pad around a second end of the protection component and the first substrate layer.

20. The method of claim 16, wherein the first and second foil layers have a higher resistance than the first and second electrode layers.

21. The method of claim 16, further comprising connecting the first foil layer to the first electrode.
